(19) United States
(12) Patent Application Publication
(10) Pub. No.: US 2020/0189422 A1
(43) Pub. Date: Jun. 18, 2020

(54) SEAT TRACK MECHANISM FOR VEHICLE

(71) Applicant: HYUNDAI TRANSYS INC., Seosan-si (KR)

(72) Inventors: Jae Sung LEE, Osan-si (KR); Hwa Young MUN, Hwaseong-si (KR); Jae Sang LIM, Osan-si (KR)

(21) Appl. No.: 16/529,983

(22) Filed: Aug. 2, 2019

(30) Foreign Application Priority Data
Dec. 17, 2018 (KR) 10-2018-0163414

(51) Int. Cl. B60N 2/06; B60N 2/07

(52) U.S. Cl. CPC B60N 2/067; B60N 2/242; B60N 2/0725

(57) ABSTRACT

A seat track mechanism for installing beneath a vehicle seat in order to move the vehicle seat in the forward and backward directions includes a monotrack mechanism, to which a monopost structure and a single rail structure are applied, installed at the bottom of the seat. Upper and lower rails of the mono track mechanism hook-engage with each other by hook guides. Accordingly, the seat track mechanism can secure sufficient strength upon head-on or rear-end collision.

### CROSS-REFERENCE TO RELATED APPLICATION

This application claims the benefit of priority under 35 U.S.C. § 119(a) to Korean Patent Application No. 10-2018-0163414 filed on Dec. 17, 2018, the entire contents of which are incorporated herein by reference.

### BACKGROUND

### (a) Technical Field

The present disclosure relates generally to a seat track mechanism for a vehicle, and more particularly to a seat track mechanism installed beneath a vehicle seat in order to move the vehicle seat in the forward and backward directions.

### (b) Background Art

Various components are provided as part of the seat of a vehicle in order to provide enhanced ride comfort and convenience to a driver or passenger. One of such component is a seat track mechanism configured to move a seat forward and rearward on the basis of the body form of a driver or passenger sitting thereon. Such a seat track mechanism includes a pair of rails installed beneath a seat at opposite sides of the seat so that the seat can move forward and rearward along the rails.

Such a seat track mechanism includes a lower rail installed at the bottom of the vehicle, and an upper rail adapted to move forward and rearward along the lower rail. In particular, a seat is mounted on the upper rail. As actuating force to move the seat and the upper rail is applied, the seat is moved forward or rearward. In addition, the seat track mechanism includes a locking device for locking the seat at a specific position after movement of the seat to the specific position.

Meanwhile, in such a conventional seat track mechanism, the pair of rails installed beneath the seal limit seat movement or motion to forward or rearward movement. The limitations imposed by these rails are problematic in that certain operations, such as rotation of the seat, are fundamentally impossible.

The above information disclosed in this background section is only for enhancement of understanding of the background of the technology and therefore it may contain information that does not form the prior art that is already known in this country to a person of ordinary skill in the art.

### SUMMARY OF THE DISCLOSURE

Certain embodiments of the present disclosure have been made in an effort to solve the above-described problems associated with the prior art.

Embodiments of the present disclosure include a seat track mechanism for a vehicle. The track structure thereof is for mounting to the bottom of a seat. The track structure employs a single rail structure rather than a double rail structure, thereby achieving improved movement or motion of the seat, slimness and autonomy associated with design of the seat bottom, and a simplification in structure through a reduction in the number of constituent elements.

Embodiments of the present disclosure also include a seat track mechanism capable of securing sufficient strength upon head-on or rear-end collision in spite of the application of a single rail structure.

In one aspect, a seat track mechanism for a vehicle includes a lower rail for fixing to a body of the vehicle, and an upper rail provided with a monopost mounted thereto to support a seat of the vehicle, the upper rail being movable forward and rearward along the lower rail.

In an embodiment, the upper rail may include a central body, to which the monopost is mounted, and a pair of wings extending left and right from the body, and the lower rail may include a pair of covers each enclosing at least a portion of an associated one of the wings in the upper rail.

In still another embodiment, the seat track mechanism may further include a driver for providing actuating force to move the upper rail forward and rearward along the lower rail.

In yet another embodiment, the driver may include a lead screw rotatably mounted to the lower rail, a motor for rotating the lead screw, and a nut member mounted to the upper rail and formed with female threads having a shape corresponding to a screw shape of the lead screw. The nut member may move forward and rearward in accordance with rotation of the lead screw.

In still yet another embodiment, the upper rail may include a central body, to which the monopost is mounted, and a pair of wings extending left and right from the body. The nut member may be mounted in the body of the upper rail. A through hole, through which the lead screw extends, may be formed through the body of the upper rail.

In still yet another embodiment, the upper rail and the lower rail may be formed with hook guides extending in a bent state to form guide grooves, respectively. The hook guide of the lower rail and the hook guide of the upper rail may hook-engage with each other.

In still yet another embodiment, the upper rail may include a central body, to which the monopost is mounted, and a pair of wings extending left and right from the body. The hook guide of the upper rail may include first and second upper hook guides formed at the body of the upper rail, and third and fourth upper hook guides respectively formed at the wings of the upper rail. The hook guide of the lower rail may include first and second lower hook guides symmetrically formed at a central portion of the lower rail, to hook-engage with the first and second upper hook guides of the upper rail, and third and fourth lower hook guides respectively laterally formed outside the first and second lower hook guides to correspond to the third and fourth upper hook guides.

In still yet another embodiment, the lower rail may include a pair of covers each enclosing at least a portion of an associated one of the wings in the upper rail. The third and fourth lower hook guides may be formed at the covers, respectively.

In still yet another embodiment, the hook guides of the upper rail and the hook guides of the lower rail may have an L-shaped cross-sectional structure, and may be oriented in different directions.

In still yet another embodiment, the first and second lower hook guides may have engagement heights equal to each other and corresponding to a first height, respectively. The third and fourth lower hook guides may have engagement heights equal to each other and corresponding to a second height, respectively. The first and second heights may differ from each other.

In still yet another embodiment, two or more rollers may be installed at each of the wings in the upper rail along a longitudinal direction of the upper rail. The third and fourth upper hook guides may be formed outside the rollers with reference to a center of the upper rail, respectively.

In still yet another embodiment, the upper rail and the lower rail may be spaced apart from each other, and at least one retainer may be interposed between the upper rail and the lower rail.

In still yet another embodiment, the at least one retainer may include a pair of retainers mounted on the wings of the upper rail while extending in a longitudinal direction of the upper rail, respectively.

In still yet another embodiment, each of the retainers may be formed with protrusions extending toward contact surfaces of the lower rail to contact the retainer, respectively, while having an inner hollow structure.

Other aspects and embodiments of the disclosure are discussed infra.

It is understood that the terms “vehicle”, “vehicular” and other similar terms as used herein are inclusive of motor vehicles in general such as passenger automobiles including sport utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a perspective view illustrating a seat for a vehicle to which a seat track mechanism according to an exemplary embodiment of the present disclosure is mounted;

FIG. 2 is a perspective view illustrating a monotrack structure mounted to the bottom of a seat included in the seat track mechanism according to the exemplary embodiment;

FIG. 3 is a perspective view illustrating the seat track mechanism according to the exemplary embodiment;

FIG. 4 is an exploded perspective view illustrating the detailed configuration of the seat track mechanism shown in FIG. 3;

FIG. 5 a cross-sectional view of the seat track mechanism according to the exemplary embodiment taken along line B-B′ in FIG. 2;

FIG. 6 is a perspective view illustrating a lower rail of the seat track mechanism according to the exemplary embodiment; and

FIG. 7 is a cross-sectional view of the seat track mechanism according to the exemplary embodiment taken along line B-B′ in FIG. 2.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts throughout the several figures of the drawing.

### DETAILED DESCRIPTION

Hereinafter reference will be made in detail to various embodiments of the present disclosure, examples of which are illustrated in the accompanying drawings and described below. While the technology will be described in conjunction with exemplary embodiments, it will be understood that the present description is not intended to limit the disclosure to the exemplary embodiments. On the contrary, the disclosure is intended to cover not only the exemplary embodiments, but also various alternatives, modifications, equivalents and other embodiments, which may be within the spirit and scope of the disclosure as defined by the appended claims.

Embodiments of the present disclosure include to a seat track mechanism for a vehicle, and a seat track mechanism for a vehicle in which a monopost and a monotrack are applied to the bottom of a seat in order to achieve slimness in design of the seat bottom and to secure freedom of movement of the seat. In particular, in embodiments of the present disclosure, a monopost structure is applied in order to achieve various seat operations required in an autonomous vehicle, and a rail structure for sliding the monopost structure forward and rearward is installed beneath the monopost structure. Embodiments of the present disclosure also include a safe seat track mechanism capable of achieving sufficient strength reinforcement coping with external collision of the vehicle in association with application of a monopost structure and a single rail structure.

Hereinafter, a seat track mechanism for a vehicle according to an exemplary embodiment of the present disclosure will be described with reference to the annexed drawings.

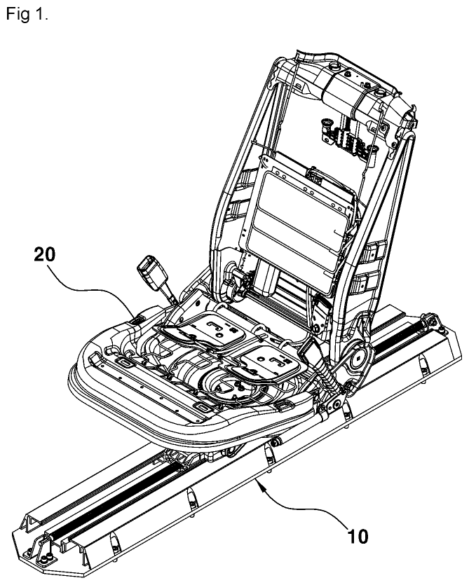

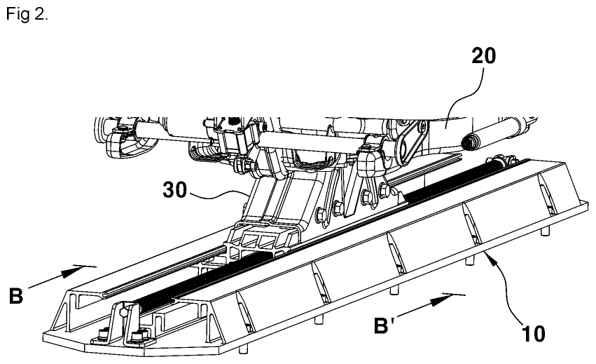

FIG. 1 illustrates a seat for a vehicle to which a seat track mechanism according to an exemplary embodiment of the present disclosure is mounted. FIG. 2 is a monotrack structure mounted to the bottom of a seat according to the exemplary embodiment. The monotrack structure is included in the seat track mechanism.

As illustrated in FIGS. 1 and 2, in association with the vehicle seat track mechanism according to the exemplary embodiment of the present disclosure, a monopost 30 is installed on a lower portion of a seat 20. In detail, the monopost 30 is installed on a seat rail in such a manner that the monopost 30 is slidable forward and rearward.

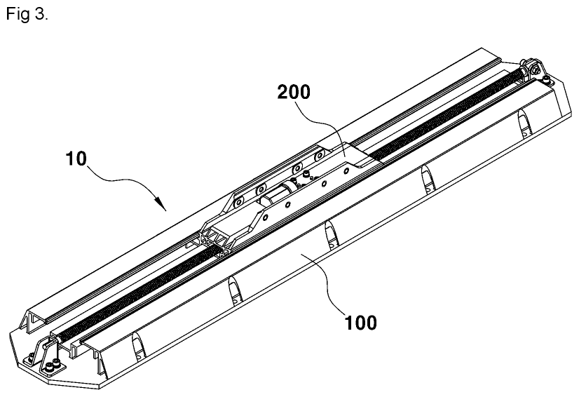

In particular, as illustrated in FIG. 2, the monopost 30 installed on the lower portion of the vehicle seat 20 may be a structure having a single post shape. The monopost 30 is mounted on an upper rail 200 (see FIG. 3). The upper rail 200, on which the monopost 30 is mounted, is coupled to a lower rail 100 in such a manner that the upper rail 200 is slidable on the lower rail 100. The upper rail 200 may, for example, receive a sliding operation force from a driver that includes a motor 320. Accordingly, the seat mounted on the upper rail 200 can move forward and rearward along the lower rail 100 fixed to a vehicle body by means of the upper rail 200 and the monopost 30.

Thus, the vehicle seat track mechanism according to the exemplary embodiment of the present disclosure is a seat track mechanism 10 suitable for the monopost structure installed on the lower portion of the seat, and is characterized by providing a monotrack mechanism including the upper rail 200 connected to the monopost 30 and the lower rail 100 configured to allow sliding of the upper rail 200 thereon.

In describing embodiments of the present disclosure, seat rails including the upper rail 200 and lower rail 100, and the driver including a lead screw 310 as well as the motor 320 to enable sliding of the upper rail 200 are collectively referred to as the “seat track mechanism 10”. In this regard, reference to the seat track mechanism 10 in the present disclosure refers to the entirety of the mechanism coupled to the monopost 30 mounted on the lower portion of the seat in order to move the seat. Configurations disposed beneath the monopost 30 in FIG. 2 may be referred to as the “seat track mechanism 10”.

Meanwhile, although the illustrated exemplary embodiment of the present disclosure described in conjunction with the figures proposes an example in which the seat track mechanism includes the motor-driven driver operating by the motor 320, a manually-driven driver may be used rather than the motor-driven driver. That is, the seat track mechanism may have a configuration in which the driver or passenger slides the seat by directly applying operating force to the seat, and locks the seat at a desired position by a locking device included in the seat track mechanism. In addition, although the illustrated embodiment proposes the motor-driven driver including the motor 320 and the lead screw, drivers of other types may be used, so long as they are applicable to the monotrack structure capable of achieving sliding of the upper rail 200.

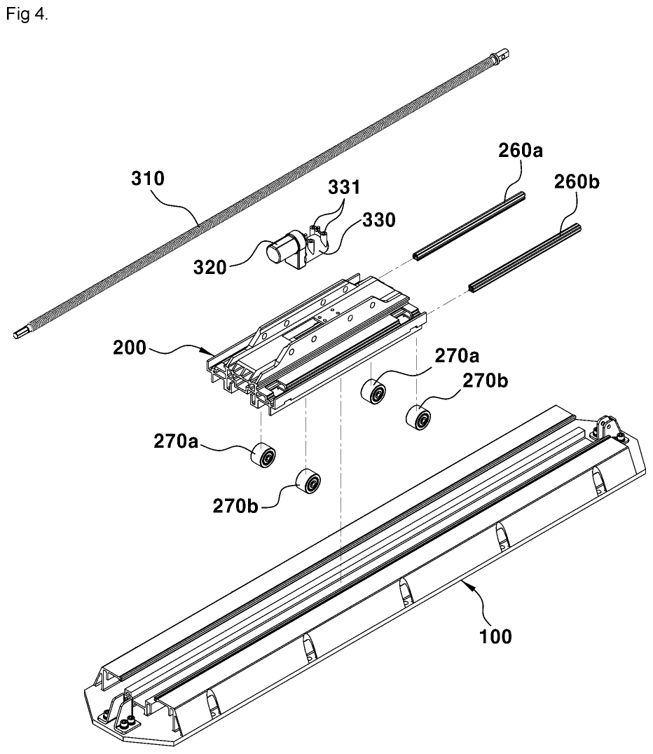

FIG. 3 illustrates a detailed configuration of the above-described seat track mechanism 10. FIG. 4 illustrates an exploded state of the detailed configuration of the seat track mechanism 10 shown in FIG. 3.

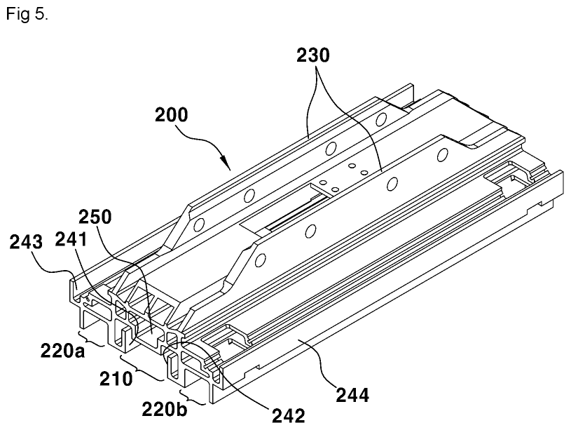

Referring to FIGS. 3 and 4, the vehicle seat track mechanism according to the illustrated embodiment has a configuration including the lower rail 100 for mounting to the vehicle body at a lower portion of the vehicle, and the upper rail 200 coupled to the lower rail 100 in such a manner that the upper rail 200 moves forward and rearward along the lower rail 100. In particular, the upper rail 200 in the illustrated embodiment is a configuration for mounting and supporting the monopost 30. That is, the upper rail 200 is configured to slide forward and rearward while substantially supporting the seat to which the monopost 30 is mounted. To this end, a mounting bracket 230 (see FIG. 5) may be formed at an upper end of the upper rail 200, for mounting of the monopost 30. The monopost 30 may be mounted to the mounting bracket 230. Although FIG. 4 illustrates an example in which a pair of mounting brackets 230 is formed at the upper end of the upper rail 200, it should be understood that the present disclosure is not limited to this particular arrangement. For example, the number and shape of the mounting brackets 230 may be varied. Indeed, any number and shape of the mounting brackets 230 may be applied without limitation, so long as the mounting brackets 230 allow mounting and fixing of the monopost 30 thereto beneath the seat without interfering with movement of the upper rail 200. The upper rail 200 and lower rail 100 may be made of a metal material, for example, aluminum.

In addition, the upper rail 200 of the vehicle seat track mechanism according to the present disclosure is slidable along the lower rail 100. In the illustrated embodiment, the upper rail 200 is configured to move forward and rearward while sliding, with the sliding being accomplished by the driver. As illustrated in FIGS. 3 and 4, the vehicle seat track mechanism according to the illustrated embodiment includes the lead screw 310, which extends in a longitudinal direction of the lower rail 100 and is fixed to opposite longitudinal ends of the lower rail 100, and the motor 320, which rotates the lead screw 310. Although not shown, the motor 320 has a rotational shaft connectable to a gearing for transmitting rotational force to the lead screw 310. Alternatively, the rotational shaft of the motor 320 may be directly connected to the lead screw 310.

In addition, a nut member 330 formed with female threads having a shape corresponding to a screw shape of the lead screw 310 is coupled to the lead screw 310. The nut member 330 is mounted on the upper rail 200. Accordingly, as the lead screw 310 rotates, the nut member 330 mounted on the upper rail 200 moves forward or rearward. When the motor 320 is driven, the upper rail 200 moves forward or rearward along the lead screw 310, together with the nut member 330.

In this case, the nut member 330 may have a structure in which the female threads corresponding to the shape of the lead screw 310 are formed at an inner portion of the nut member 330, and a plurality of bolt holes is formed at an outer portion of the nut member 330, for mounting of the nut member 330 to the upper rail 200. In the example of FIG. 4, four bolt holes are formed at an upper portion of the nut member 330. When bolting is achieved at the four bolt holes, the nut member 330 is firmly fastened to the upper rail 200. Accordingly, as the lead screw 310 rotates during driving of the motor 320, the nut member 330 and the upper rail 200, which are coupled to the lead screw 310, move forward or rearward.

To this end, as illustrated in FIG. 5, the upper rail 200 is provided with a fastening section, to which the nut member 330 is fastened, and a through hole 250, through which the lead screw 310 extends.

In an exemplary embodiment of the present disclosure, the upper rail 200 includes a body 210, to which the nut member 330 is mounted and fastened, and a through hole 250, through which the lead screw 310 extends, is formed through the body 210. In addition, a pair of wings 220a and 220b is formed at the body 210, to extend longitudinally from opposite lateral ends of the body 210. Hook guides are also provided at the body 210 and the wings 220a and 220b.

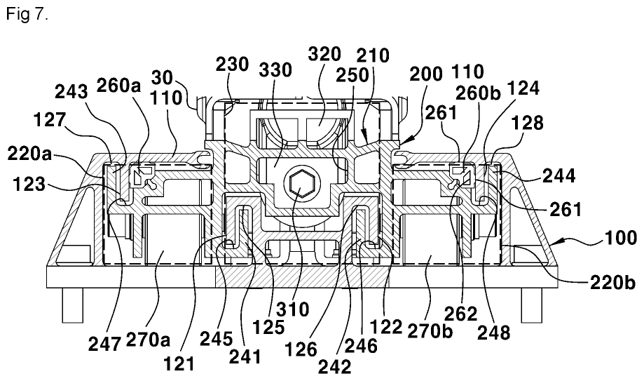

The lower rail 100 is configured to have a structure enclosing at least a portion of each of the wings 220a and 220b in the upper rail 200, to enable the seat track structures connected by the monopost 30 to provide sufficient structural stability. That is, as illustrated in FIGS. 2 and 7, etc., the wings 220a and 220b of the upper rail 200 are configured to be sufficiently enclosed by opposite covers 110 of the lower rail 100. Hook engagement is achieved inside the covers 110 by means of hook guides of the upper rail 200 and lower rail 100. The configuration of the hook guides and the hook engagement by the hook guides will be described in more detail below.

The lead screw 310 may be inserted into the upper rail 200 through the through hole 250 under the condition that the nut member 330 is coupled to the lead screw 310. In this state, the lead screw 310 is rotatably mounted to front and rear mounting brackets 131 and 132 of the lower rail 100.

In addition, to assist forward and rearward movement of the upper rail 200, a plurality of rollers 270a and 270b may be mounted on a lower portion of the upper rail 200. The rollers 270a and 270b may be rotatably mounted to the upper rail 200, to allow forward and rearward movement of the upper rail 200 while being in linear contact with the lower rail 100 at bottom surfaces thereof. The rollers 270a and 270b may include a left roller (designated by reference numeral “270a”) arranged at the left side of the upper rail 200 and a right roller (designated by reference numeral “270b”) arranged at the right side of the upper rail 200. Two left rollers and two right rollers may be installed, as illustrated in FIG. 4.

That is, the seat track mechanism according to the illustrated embodiment has configurations in which the upper rail 200 is moved forward and rearward by the rollers as well as the driver including the motor 320 and the lead screw 310, and the lower rail 100 disposed beneath the upper rail 200 guides movement of the upper rail 200 while achieving mounting of the lead screw 310 thereto.

In addition, the vehicle seat track mechanism according to the illustrated embodiment of the present disclosure is configured to be connected to a single post, that is, the monopost 30, as a post for connecting the seat track mechanism to the seat 20. In connection with this, the seat track mechanism is configured to solve movement of the seat 20 transferred to the upper rail 200 via the monopost 30 and concentration of load caused by movement of the seat 20. In particular, the vehicle seat track mechanism according to the illustrated embodiment of the present disclosure is characterized in that the upper rail 200 and the lower rail 100 are configured to be hook-engaged by rail guides extending vertically at at least four places arranged in a width direction of the seat track mechanism, in order to obtain improved strength upon lateral damage to the vehicle seat or head-on or rear-end collision.

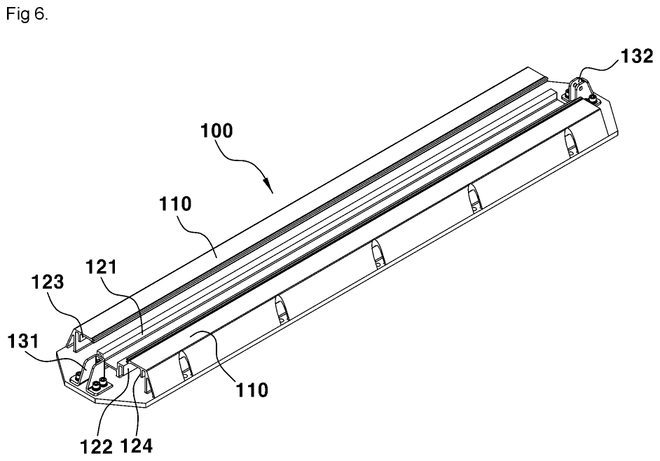

In connection with this, FIGS. 5 and 6 illustrate the upper rail 200 and the lower rail 100 in the seat track mechanism according to the exemplary embodiment of the present disclosure, respectively. FIG. 7 shows a cross-section of the seat track mechanism taken along line B-B′ in FIG. 2.

As illustrated in FIG. 7, in the seat track mechanism according to the exemplary embodiment of the present disclosure, hook type rail guides formed at the upper rail 200 and the lower rail 100 hook-engage with one another while extending in a sliding direction of the upper rail 200 and alternating with one another.

In detail, as illustrated in FIG. 7, the lower rail 100 includes four hook guides 121, 122, 123 and 124 formed to extend in a longitudinal direction of the lower rail 100. The hook guides 121, 122, 123 and 124 hook-engage with hook guides 241, 242, 243 and 244 of the upper rail 200. The hook guides 121, 122, 123, 124, 241, 242, 243 and 244 extend from the corresponding upper rail 200 or lower rail 100 in a bent state while forming guide grooves 125, 126, 127, 128, 245, 246, 247 and 248, respectively, and restrain one another in such a manner that one hook guide is fitted in the guide groove formed by another hook guide.

As illustrated in the cross-sectional view of FIG. 7, each hook guide may extend in the longitudinal direction of the corresponding seat rail while having an L-shaped cross-section open at one side thereof. Each hook guide may be configured to have one end mounted to the corresponding seat rail, that is, the lower rail 100 or the upper rail 200, and the other end functioning as an engagement end to engage with a portion of another hook guide engaging with the former hook guide. That is, one end of each hook guide in the illustrated embodiment of the present disclosure is mounted to the upper rail 200 or lower rail 100, to be integrated with the upper rail 200 or lower rail 100, and the other end of the hook guide extends from one end of the hook guide while being bent from one end of the hook guide, to form a hook-shaped cross-section. In the present disclosure, the other end of the hook guide is referred to as an “engagement end”, for convenience.

In the present disclosure, accordingly, hook engagement of the hook guides means that each hook guide of the lower rail (or the upper rail) is fitted in the guide groove of the hook guide of the upper rail (or the lower rail) adjacent to the former hook guide of the lower rail (or the upper rail) and, as such, the former and latter hook guides engage with each other in a state allowing sliding movement of the upper rail while restraining relative movement therebetween in other directions by the engagement ends thereof. Of course, in this case, the engagement end of the hook guide of the upper rail (or the lower rail) may also be fitted in the guide groove of the hook guide of the lower rail (or the upper rail) adjacent to the hook guide of the upper rail (or the lower rail). Accordingly, since the upper rail 200 and the lower rail 100 engage with each other by means of the hook guides, as shown in FIG. 7, the upper rail 200 and the lower rail 100 may restrain each other when relative movement therebetween in longitudinal and lateral directions is generated.

In addition, in accordance with the illustrated embodiment of the present disclosure, each of the upper rail 200 and lower rail 100 may be configured to include four hook guides, as illustrated in FIG. 7. As hook engagement is achieved at at least four places of the seat rail, it may be possible to effectively avoid separation of the lower rail 100 upon head-on or rear-end collision. That is, as illustrated in FIGS. 6 and 7, a first lower hook guide designated by reference numeral “121” and a second lower hook guide designated by reference numeral “122” are symmetrically formed at a central portion of the lower rail 100, and a third lower hook guide designated by reference numeral “123” and a fourth lower hook guide designated by reference numeral “124” are symmetrically formed at opposite sides of the central portion of the lower rail 100 outside the first and second lower hook guides 121 and 122, respectively.

Similarly, as illustrated in FIGS. 5, 6 and 7, first to fourth upper hook guides designated by reference numerals “241”, “242”, “243”, and “244” are formed on the upper rail 200 at positions corresponding to the first to fourth lower hook guides 121, 122, 123, and 124, to engage with the first to fourth lower hook guides 121, 122, 123, and 124, respectively.

In this case, the first and second upper hook guides 241 and 242 are formed at a lower surface of the body 210, namely, a central body, of the upper rail 200 connected to the monopost 30, and the third and fourth upper hook guides 243 and 244 are formed at the wings 220a and 220b extending from opposite sides of the central body 210, respectively. The rollers 270a and 270b may be installed in plural at the wings 220a and 220b of the upper rail 200, respectively, to be arranged in the longitudinal direction of the upper rail 200. For example, when referring to FIGS. 4 and 7, the rollers 270a are installed within a cavity created by the shape of the wing 220a, and the rollers 270a (in the illustrated embodiment of FIGS. 4 and 7, the two rollers 270a) are arranged in the longitudinal extension direction of the upper rail 200. Similarly, the rollers 270b are installed within a cavity created by the shape of the wing 220b, and the rollers 270b (in the illustrated embodiment of FIGS. 4 and 7, the two rollers 270b) are arranged in the longitudinal extension direction of the upper rail 200. The third and fourth upper hook guides 243 and 244 may be formed outside the rollers 270a and 270b with reference to the center of the upper rail 200, respectively. That is, left rollers (that is, the rollers 270a) are mounted on the upper rail 200 (the wing 220a of the upper rail 200) between the first upper hook guide 241 and the third upper hook guide 243, and right rollers (that is, the rollers 270b) are mounted on the upper rail 200 (the wing 220b of the upper rail 200) between the second upper hook guide 242 and the fourth upper hook guide 244.

In this case, the hook guides are arranged in pairs at opposite sides of the left and right rollers 270a and 270b with reference to the bottom surfaces of the left and right rollers 270a and 270b as contact surfaces between the upper rail 200 and the lower rail 100. Accordingly, it may be possible to effectively cope with longitudinal and lateral impact. Although the illustrated embodiment illustrates an example in which respective pairs of rollers 270a and 270b are installed at opposite sides, namely, left and right sides, as shown in FIG. 4, it should be understood that the number of rollers may be varied. For example, 4, 6, or 8 rollers may be arranged at the lower portion of the upper rail 200. On the other hand, only two rollers may be arranged at a central portion of the body 210 while being longitudinally aligned. In this case, the rollers may have a sufficient width to provide a sufficient contact area with respect to the lower rail 100.

In addition, as illustrated in FIG. 7, the engagement ends of the hook guides in the upper rail 200 and the engagement ends of the hook guides in the lower rail 100 should be oriented in opposite directions. Here, the orientation direction of each engagement end means the direction in which the associated hook guide extends from the upper rail 200 or the lower rail 100 when viewed in cross-section. Accordingly, the hook guides of the upper rail 200 may extend upward, and the hook guides of the lower rail 100 may extend downward, as shown in FIG. 7. Although FIG. 7 illustrates an example in which corresponding ones of the hook guides extend vertically in opposite directions, the extension directions of the hook guides are not limited to the vertical directions as shown in FIG. 7. For example, the hook guides may be formed to have a certain inclination with respect to the vertical directions.

Meanwhile, the engagement height of the first and second lower hook guides 121 and 122 as central lower hook guides may differ from the engagement height of the third and fourth lower hook guides 123 and 124 as outer lower hook guides, in view of strength reinforcement. Here, the “engagement height” is defined by an arithmetic average value of the bottom height in each of the guide grooves 125, 126, 127 and 128 and the height of the corresponding engagement end. That is, points, at which the upper rail 200 is restrained by the lower rail 100 upon head-on or rear-end collision in an engaged state of the hook guides according to the present disclosure, are the bottom position of each guide groove and the tip position of the corresponding engagement end when viewed in cross-section. Accordingly, in the present disclosure, the arithmetic average value of the heights of the two positions providing substantial restraint is referred to as an “engagement height”.

For example, as illustrated in FIG. 7, the engagement heights of the first and second lower hook guides 121 and 122 as the central lower hook guides may be set to be equal with reference to the lower surface of the lower rail 100, and to be positioned at a lower level than the engagement heights of the third and fourth lower hook guides 123 and 124 as the outer lower hook guides, which may be set to be equal with reference to the lower surface of the lower rail 100. When the engagement heights of the hook guides are set to be different, it may be possible to provide different engagement heights of the hook guides at different positions and, as such, it may be possible to achieve effective contribution to strength reinforcement even upon collision in various directions and to avoid separation of the seat upon collision.

As described above, the upper hook guides 241, 242, 243 and 244 are formed at the body 210 and the wings 220a and 220b in the upper rail 200, respectively, and provide a coupling structure achieving hook engagement at at least four places together with the lower hook guides 121, 122, 123 and 124 of the lower rail 100. As such, sufficient strength reinforcement may be achieved even in the monopost structure.

Although the illustrated embodiment of FIG. 7 illustrates hook engagement at four places, it should be understood that the present disclosure is not limited to this particular example, and an example in which hook engagement at more than four places is achieved may be applied.

Meanwhile, in a hook-coupled state of the upper rail 200 and the lower rail 100, the hook guides for hook engagement do not come into contact with each other during normal sliding operation of the upper rail 200. That is, in accordance with the illustrated embodiment, the upper hook guides 241, 242, 243 and 244 are arranged to be spaced apart from the lower hook guides 121, 122, 123 and 124 by a predetermined distance, as shown in FIG. 7. Meanwhile, retainers 260a and 260b are interposed between the upper rail 200 and the lower rail 100 and, as such, eliminate/accommodate space between upper rail 200 and the lower rail 100. The retainers 260a and 260b may be installed in the longitudinal direction of the upper rail 200. The retainers 260a and 260b may function to support uniform load while being in surface contact with the upper rail 200 and the lower rail 100.

Each of the retainers 260a and 260b may be configured to have a hollow structure 262 therein. Each of the retainers 260a and 260b may be fixedly mounted on the upper rail 200 while being brought into close contact with the lower rail 200 by way of the construction of the inner hollow structure 262. For example, as illustrated in FIG. 7, each of the retainers 260a and 260b may be formed with protrusions 261 that extend toward contact surfaces of the lower rail 100. The contact surfaces of the lower rail 100 are the portions of the surface of the lower rail that are to be brought into contact with the retainers 260a and 260b. The retainers 260a and 260b, which are fixedly mounted on the upper rail 200, may come into close contact with the inner surface of the lower rail 100 via the protrusions 261 and, as such, may be press-fitted between the upper rail 200 and the lower rail 100. When press-fitted, the retainers 260a and 260b are deformed inwards via the hollow structures 262 thereof and, as such, the lower rail 100 and the upper rail 200 may elastically support each other. Meanwhile, the retainers 260a and 260b may be made of plastic.

Thus, the clearance between the upper rail 200 and the lower rail 100 may be offset by the retainers 260a and 260b having the above-described structure. As a result, during sliding operation, it may be possible to avoid generation of vibration and noise and to minimize power loss.

Alternatively, the retainers 260a and 260b may be mounted on the lower rail 100, differently from the case of FIG. 4. In this case, each of the retainers 260a and 260b may be mounted on the lower rail 200 throughout the entire length of the lower rail 100.

The vehicle seat track mechanism having the above-described configuration has advantages in that the vehicle seat track mechanism is connected to the seat by the monopost in accordance with application of the monotrack structure and, as such, may obtain improved aesthetics of the seat while appropriately coping with various seat movements applicable to autonomous vehicles. Although the monopost is applied, sufficient strength performance coping with head-on or rear-end collision may be secured and, as such, there is an advantage in that vehicle stability may be maintained.

In embodiments of the present disclosure, a seat track mechanism including a monotrack mechanism having a single rail structure is provided. Accordingly, the structure of the seat bottom may be simplified and, as such, it may be possible to achieve a reduction in manufacturing costs and an elegant and slim design of the seat bottom.

Furthermore, in embodiments of the present disclosure, the monotrack mechanism is applied to a vehicle seat including a driver seat and, as such, it may be possible to achieve various seat operation modes such as seat rotation, thereby achieving an enhancement in the freedom of seat operation in an autonomous vehicle.

In addition, in embodiments of the present disclosure, the seat track mechanism has a strength-reinforced cross-sectional structure capable of minimizing vertical/lateral clearance between upper and lower rails included in the monotrack mechanism, thereby effectively preventing movement of the seat and damage to the seat even when external impact is applied to the vehicle.

The invention has been described in detail with reference to embodiments thereof. However, it will be appreciated by those skilled in the art that changes may be made in these embodiments without departing from the principles and spirit of the invention, the scope of which is defined in the appended claims and their equivalents.

What is claimed is:

1. A seat track mechanism for a vehicle comprising:
a lower rail for fixing to a body of the vehicle; and
an upper rail provided with a monopost mounted thereto to support a seat of the vehicle, the upper rail being movable forward and rearward along the lower rail.

2. The seat track mechanism according to claim 1, wherein:
the upper rail comprises a central body to which the monopost is mounted, and a pair of wings extending left and right from the central body, respectively; and
the lower rail comprises a pair of covers each enclosing at least a portion of an associated one of the wings in the upper rail.

3. The seat track mechanism according to claim 1, further comprising:
a driver for providing actuating force to move the upper rail forward and rearward along the lower rail.

4. The seat track mechanism according to claim 3, wherein the driver comprises:
a lead screw rotatably mounted to the lower rail;
a motor for rotating the lead screw; and
a nut member mounted to the upper rail and formed with threads having a shape corresponding to a screw shape of the lead screw, the nut member moving forward and rearward in accordance with rotation of the lead screw.

5. The seat track mechanism according to claim 4, wherein:
the upper rail comprises a central body, to which the monopost is mounted, and a pair of wings extending left and right from the central body, respectively; and
the nut member is mounted in the central body of the upper rail, and a through hole, through which the lead screw extends, is formed through the central body of the upper rail.

6. The seat track mechanism according to claim 1, wherein
the upper rail is formed with an upper rail hook guide extending in a bent state to form an upper rail guide groove,
the lower rail is formed with a lower rail hook guide extending in a bent state to form a lower rail guide groove, and
the upper rail hook guide and the lower rail hook guide hook-engage with each other.

7. The seat track mechanism according to claim 6, wherein:
the upper rail comprises a central body, to which the monopost is mounted, and a pair of wings extending left and right from the central body, respectively;
the upper rail hook guide comprises first and second upper hook guides formed at the central body of the upper rail, and third and fourth upper hook guides respectively formed at the wings of the upper rail; and
the lower rail hook guide comprises first and second lower hook guides symmetrically formed at a central portion of the lower rail to hook-engage with the first and second upper hook guides of the upper rail, and third and fourth lower hook guides respectively formed outside the first and second lower hook guides to correspond to the third and fourth upper hook guides.

8. The seat track mechanism according to claim 7, wherein the lower rail comprises a pair of covers each enclosing at least a portion of an associated one of the wings in the upper rail, and the third and fourth lower hook guides are formed at the covers, respectively.

9. The seat track mechanism according to claim 6, wherein the upper rail hook guide and the lower rail hook guide each have an L-shaped cross-sectional structure, and are oriented in different directions so as to hook-engage with each other.

10. The seat track mechanism according to claim 7, wherein:
the first and second lower hook guides have engagement heights equal to each other and corresponding to a first height, respectively, and the third and fourth lower hook guides have engagement heights equal to each other and corresponding to a second height, respectively; and
the first and second heights differ from each other.

11. The seat track mechanism according to claim 7, wherein two or more rollers are installed at each of the wings in the upper rail along a longitudinal direction of the upper rail, and the third and fourth upper hook guides are formed outside the rollers with reference to a center of the upper rail, respectively.

12. The seat track mechanism according to claim 1, wherein the upper rail and the lower rail are spaced apart from each other, and at least one retainer is interposed between the upper rail and the lower rail.

13. The seat track mechanism of claim 12, wherein the at least one retainer has an inner hollow structure.

14. The seat track mechanism according to claim 12, wherein the at least one retainer comprises a pair of retainers mounted on the wings of the upper rail while extending in a longitudinal direction of the upper rail, respectively.

15. The seat track mechanism according to claim 14, wherein each of the retainers is formed with protrusions extending toward contact surfaces of the lower rail to contact the retainer, respectively, and each of the retainers has an inner hollow structure.

16. A seat track mechanism for a vehicle comprising:
a lower rail for fixing to a body of the vehicle; and
an upper rail provided with a monopost mounted thereto to support a seat of the vehicle, the upper rail being movable forward and rearward along the lower rail;
wherein the lower rail comprises a lower rail hook guide and the upper rail comprises an upper rail hook guide, and the upper rail hook guide and the lower rail hook guide hook engage so as to provide restraint.

17. The seat track mechanism of claim 15, wherein
the upper rail hook guide extends in a bent state to form an upper rail guide groove and an engagement end;
the lower rail hook guide extends in a bent state to form a lower rail guide groove and an engagement end;
and the upper rail hook guide and the lower rail hook guide hook-engage with each other such that the engagement end of the upper rail hook guide is within the guide groove of the lower rail hook guide, and the engagement end of the lower rail hook guide is in the guide groove of the upper rail hook guide.

18. The seat track mechanism according to claim 17, wherein:
the upper rail comprises a central body, to which the monopost is mounted, and a pair of wings extending left and right from the central body, respectively;
the upper rail hook guide comprises first and second upper hook guides formed at the central body of the upper rail, and third and fourth upper hook guides respectively formed at the wings of the upper rail; and
the lower rail hook guide comprises first and second lower hook guides symmetrically formed at a central portion of the lower rail to hook-engage with the first and second upper hook guides of the upper rail, and third and fourth lower hook guides respectively formed outside the first and second lower hook guides to correspond to the third and fourth upper hook guides.

19. The seat track mechanism according to claim 18, wherein the lower rail comprises a pair of covers each enclosing at least a portion of an associated one of the wings in the upper rail, and the third and fourth lower hook guides are formed at the covers, respectively.

20. The seat track mechanism according to any one of claim 18, wherein the upper rail hook guide and the lower rail hook guide each have an L-shaped cross-sectional structure, and are oriented in different directions so as to hook-engage with each other.
